(19) United States
(12) Patent Application Publication
(10) Pub. No.: US 2017/0118055 A1
(43) Pub. Date: Apr. 27, 2017

(54) Flexible and Scalable Air Interface for Mobile Communication

(71) Applicant: MEDIATEK INC., Hsinchu (TW)

(72) Inventors: Jiann-Ching Guey, Hsinchu City (TW); Chun-Hsuan Kuo, San Diego, CA (US); Pei-Kai Liao, Nantou County (TW)

(21) Appl. No.: 15/299,116

(22) Filed: Oct. 20, 2016

Related U.S. Application Data
(60) Provisional application No. 62/244,803, filed on Oct. 22, 2015.

(51) Int. Cl. H04L 27/26; H04L 1/00; H04W 72/04; H04L 5/00

(52) U.S. Cl. CPC H04L 27/2607; H04L 5/0044; H04L 1/0005; H04L 1/0084; H04L 1/0042; H04W 72/042

(57) ABSTRACT

A flexible time-frequency grid is proposed. A baseline OFDM format consisting of CP and a following symbol interval is scaled in time to generate a set of extended OFDM frame formats. The set of extended OFDM frame formats is further extended by scaling in bandwidth. The OFDM frame formats and the extended OFDM frame format set are used dynamically in the wireless communication system in accordance to the changes of the communication environment. Furthermore, various methods are proposed to avoid and/or combat performance degradation of the resource elements (REs) interfered by non-orthogonal REs in the neighborhood due to different OFDM symbol configurations in the flexible time-frequency grid.

### CROSS REFERENCE TO RELATED APPLICATIONS

This application claims priority under 35 U.S.C. §119 from U.S. Provisional Application No. 62/244,803, entitled “Flexible and Scalable Air Interface for Mobile Communication,” filed on Oct. 22, 2015; the subject matter of which is incorporated herein by reference.

### TECHNICAL FIELD

The disclosed embodiments relate generally to wireless communication, and, more particularly, to resource allocation with a flexible and scalable time-frequency grid in mobile communication systems.

### BACKGROUND

Long Term Evolution (LTE) is an improved universal mobile telecommunication system (UMTS) that provides higher data rate, lower latency and improved system capacity. In LTE systems, an evolved universal terrestrial radio access network includes a plurality of base stations, referred as evolved Node-Bs (eNBs), communicating with a plurality of mobile stations, referred as user equipment (UE). A UE may communicate with a base station or an eNB via the downlink and uplink. The downlink (DL) refers to the communication from the base station to the UE. The uplink (UL) refers to the communication from the UE to the base station. LTE is commonly marketed as 4G LTE, and the LTE standard is developed by 3GPP.

Orthogonal Frequency Division Multiplexing (OFDM) is an efficient multiplexing scheme to perform high transmission rate over frequency selective channel without the disturbance from inter-carrier interference. In LTE OFDM systems, resource allocation is based on a regular time-frequency grid. OFDM symbols with the same numerology are allocated across the whole time-frequency grid. Cyclic Prefix (CP) is added to each OFDM symbol to avoid inter symbol interference (ISI). Reference signals are located at pre-defined locations within the time-frequency grid to enable channel estimation.

In next generation 5G LTE, in order to meet the requirement for different types of services, OFDM symbols with different numerologies need to be supported simultaneously within the same time-frequency grid. Flexible time-frequency grid is thus desired to fulfill such requirement. However, in the flexible time-frequency grid, neighbor OFDM symbols along the frequency axis with different numerology becomes non-orthogonal, causing interference to each other, particularly along the OFDM symbol boundary.

A solution is sought to support resource allocation in the flexible time-frequency grid, and to avoid/combat performance degradation of the resource elements (REs) interfered by non-orthogonal REs in the neighborhood due to different OFDM symbol configurations in the flexible time-frequency grid.

### SUMMARY

A flexible time-frequency grid is proposed. A baseline OFDM format consisting of cyclic prefix and a following OFDM symbol interval is scaled in time to generate a set of extended OFDM frame formats. The set of extended OFDM frame formats is further extended by scaling in bandwidth. The OFDM frame formats and the extended OFDM frame format set are used dynamically in the wireless communication system in accordance to the changes of the communication environment. Furthermore, various methods are proposed to avoid/combat performance degradation of the resource elements (REs) interfered by non-orthogonal REs in the neighborhood due to different OFDM frame formats in the flexible time-frequency grid.

In one embodiment, a base station allocates a first set of resource elements for data transmission to a first user equipment (UE) in an OFDM wireless communication network. The first set of resource elements is configured with a first OFDM frame format. The base station allocates a second set of resource elements by the base station for data transmission to a second UE. The second set of resource elements is configured with a second OFDM frame format. The base station transmits a first data to the first UE over the first set of resource elements. The base station transmits a second data to the second UE over the second set of resource elements. The first set of resource elements and the second set of resource elements overlap in time domain.

In another embodiment, a user equipment (UE) receives control signaling information from a base station in an OFDM wireless communication network. The UE receives a first data signal over a first set of resource elements. The first set of resource elements is configured with a first OFDM frame format. The UE identifies subcarriers that suffer from inter-carrier interferences (ICI) from a second data signal transmitted over a second set of resource elements intended to another UE. The second set of resource elements is configured with a second OFDM frame format. The UE performs channel estimation and interference cancellation enhancement based on the control signaling information.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates resource allocation with flexible time-frequency grid in a wireless OFDM communication system in accordance with one novel aspect.

FIG. 2 is a simplified block diagram of a base station and a user equipment that carry out certain embodiments of the present invention.

FIG. 3 illustrates the concept of a scalable numerology for flexible time-frequency grid.

FIG. 4 illustrates examples of resource allocation formats with flexible time-frequency grid.

FIG. 5 illustrates examples of different resource allocation formats and corresponding system bandwidths and FFT sizes with flexible time-frequency grid.

FIG. 6 illustrates a first embodiment of identifying interfered subcarriers and improving system robustness.

FIG. 7 illustrates a second embodiment of identifying interfered subcarriers and improving system robustness.

FIG. 8 illustrates a third embodiment of identifying interfered subcarriers and improving system robustness.

FIG. 9 illustrates one embodiment of interference mitigation with flexible time-frequency grid.

FIG. 10 illustrates another embodiment of channel estimation with flexible time-frequency grid.

FIG. 11 illustrates message flows between a base station and one or more user equipments for data transmission with flexible time-frequency grid.

FIG. 12 is a flow chart of a method of using a flexible time-frequency grid from base station perspective in accordance with one novel aspect.

FIG. 13 is a flow chart of a method of using a flexible time-frequency grid from user equipment perspective in accordance with one novel aspect.

### DETAILED DESCRIPTION

Reference will now be made in detail to some embodiments of the invention, examples of which are illustrated in the accompanying drawings.

FIG. 1 illustrates resource allocation with flexible time-frequency grid in a wireless OFDM communication system 100 in accordance with one novel aspect. Wireless OFDM network 100 comprises a base station BS 101 and user equipments UE 102 and UE 103. For downlink transmission, BS 101 allocates radio resources for control and data signals to be transmitted to UE 102 and UE 103. In 3GPP LTE systems based on OFDM downlink, the radio resource is partitioned into subframes in time domain, each subframe is comprised of two slots and each slot has seven OFDMA symbols in the case of normal Cyclic Prefix (CP), or six OFDMA symbols in the case of extended CP. Each OFDMA symbol further consists of a number of OFDMA subcarriers in frequency domain depending on the system bandwidth. The basic unit of the resource grid is called Resource Element (RE), which spans an OFDMA subcarrier over one OFDMA symbol. In 4G LTE systems, resource allocation is based on a regular time-frequency grid. OFDM symbols with the same numerology are allocated across the whole time-frequency grid. CP is added to each OFDM symbol to avoid inter symbol interference (ISI). Reference signals are located at pre-defined locations within the time-frequency grid to enable channel estimation.

In next generation 5G LTE systems, in order to meet the requirement for different types of services, OFDM symbols with different numerologies need to be supported simultaneously within the same time-frequency grid. Flexible time-frequency grid is thus desired to fulfill such requirement. However, in the flexible time-frequency grid, neighbor OFDM symbols along the frequency axis with different numerology becomes non-orthogonal, causing interference to each other, particularly along the OFDM symbol boundary.

In accordance with one novel aspect, a flexible time-frequency grid is proposed. A baseline OFDM format consisting of CP and a following symbol interval is scaled in time to generate a set of extended OFDM frame formats. The set of extended OFDM frame formats is further extended by scaling in bandwidth. The OFDM frame formats and the extended OFDM frame format set are used dynamically in the wireless communication system in accordance to the changes of the communication environment such as: the device's capability in receiving signals of different bandwidths; channel condition (delay spread before and after beamforming); traffic characteristics with different latency requirements; and deployment scenarios (macro or small cells).

Furthermore, various methods are proposed to avoid/combat performance degradation of the resource elements (REs) interfered by non-orthogonal REs in the neighborhood due to different OFDM symbol configurations in the flexible time-frequency grid. The various methods include: define and use guard subcarriers, reference signal (RS) location design, channel estimation enhancement, and interference cancellation enhancement based on RS sharing for neighbor resource allocation.

In the example of FIG. 1, a flexible time-frequency grid 110 is used by BS 101 for resource allocation. BS 101 allocates resource elements 121 and 122 for data transmission to UE 102, and allocates resource element 131 for data transmission to UE 103. Note that resource elements 121, 122 and resource element 131 have different OFDM frame formats, and yet they overlap in time domain, i.e., the mixing of different OFDM frame formants occurs in the same time interval or during the same subframe. Because the neighbor OFDM symbols along the frequency axis with different numerology becomes non-orthogonal, data signal 123 intended for UE 102 and data signal 133 intended for UE 103 interfere with each other. BS 101 employs various method to avoid and/or combat the performance degradation.

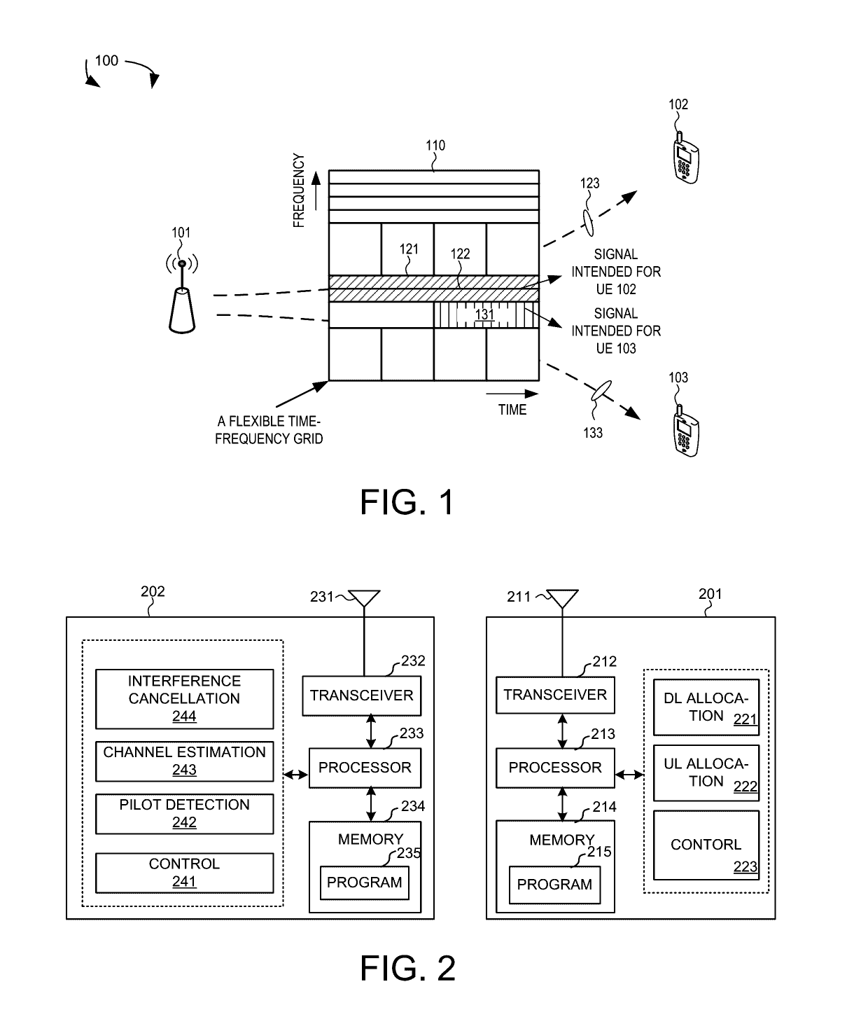

FIG. 2 is a simplified block diagram of a base station and a user equipment that carry out certain embodiments of the present invention. BS 201 has an antenna array 211 having multiple antenna elements that transmits and receives radio signals, one or more RF transceiver modules 212, coupled with the antenna array, receives RF signals from antenna 211, converts them to baseband signal, and sends them to processor 213. RF transceiver 212 also converts received baseband signals from processor 213, converts them to RF signals, and sends out to antenna 211. Processor 213 processes the received baseband signals and invokes different functional modules to perform features in BS 201. Memory 214 stores program instructions and data 215 to control the operations of BS 201. BS 201 also includes multiple function modules and circuits that carry out different tasks in accordance with embodiments of the current invention.

Similarly, UE 202 has an antenna 231, which transmits and receives radio signals. A RF transceiver module 232, coupled with the antenna, receives RF signals from antenna 231, converts them to baseband signals and sends them to processor 233. RF transceiver 232 also converts received baseband signals from processor 233, converts them to RF signals, and sends out to antenna 231. Processor 233 processes the received baseband signals and invokes different functional modules to perform features in UE 202. Memory 234 stores program instructions and data 235 to control the operations of UE 202. UE 202 also includes multiple function modules and circuits that carry out different tasks in accordance with embodiments of the current invention.

The functional modules and circuits can be implemented and configured by hardware, firmware, software, and any combination thereof. For example, from BS side, DL scheduler/allocation module 221 and UL scheduler/allocation module 222 schedules and allocates radio resource blocks for UL and DL transmission, and control circuit 223 identifies interfered subcarriers based on the scheduling information and thereby determining methods to improve robustness against interference. Note that the term “allocate” can be an explicit action performed by the BS to configure and reserve certain resource blocks, but it can also be an implicit action of following a predefined agreement based on a standard specification. From UE side, control circuit 241 receives control signaling from its serving BS, pilot detection circuit 242 detects reference signals, channel estimation circuit 243 performs channel estimation based on detected reference signals, and interference cancellation circuit 244 performs interference cancellation of interfering signals. In one example, the control signaling carries information of reference signals transmitted over neighbor subcarriers. As a result, UE 202 is able to perform channel estimation enhancement via interpolation and also perform interference cancellation by decoding and reconstructing interfering signals over the neighbor subcarriers.

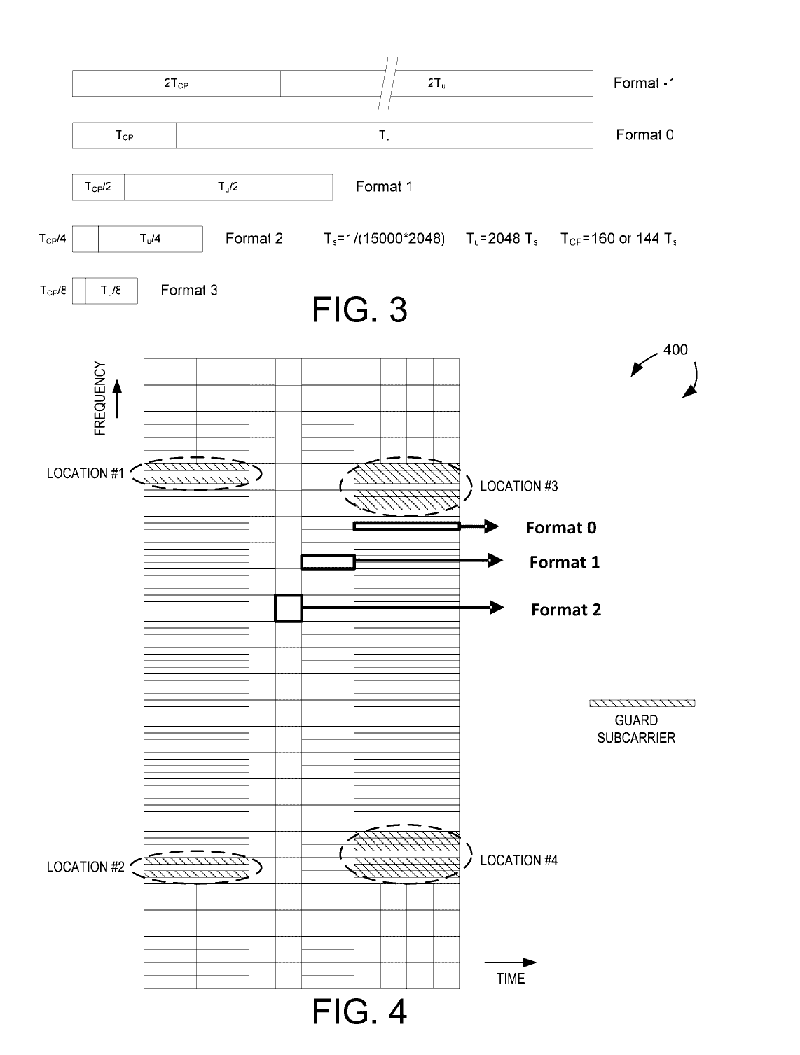

FIG. 3 illustrates the concept of a scalable numerology for flexible time-frequency grid. A baseline OFDM frame format (Format 0) is first defined with a sampling rate T_{S}=1/(15000*2048). Format 0 also defines an OFDM interval T_{U}=2048Tₛ, and a CP length T_{CP}=160 or 144T_{S}. The baseline sampling rate and FFT size change according to system bandwidth and UE capability. In one example, Format −1 defines a OFDM interval of 2T_{U}, and a CP length of 2T_{CP}; Format 1 defines a OFDM interval of ½T_{U}, and a CP length of ½T_{CP}; Format 2 defines a OFDM interval of ¼T_{U}, and a CP length of ¼T_{CP}; Format 3 defines a OFDM interval of ⅛T_{U}, and a CP length of ⅛T_{CP}; and so on so forth. A serving base station may switch between dynamically or statically OFDM frame formats according to factors such as UE capability, channel condition, traffic characteristics, and deployment scenarios.

As illustrated in FIG. 3, the baseline OFDM format (Format 0) consists of CP and a following symbol interval is scaled in time to generate a set of extended OFDM frame formats. The scaling in time is the doubling or halving of the baseline format. The doubling and halving in time apply to both the cyclic prefix and the symbol intervals of the baseline format. The scaling in time can be further performed on the previously doubled or halved formats. The set of extended OFDM frame formats is further extended by scaling in bandwidth. The scaling in bandwidth is the doubling or halving of the sampling rate of an OFDM frame format. The doubling or halving of the sampling rate of an OFDM frame format results in the doubling or halving of the number of samples in an OFDM frame format. The doubling or halving of the number of samples in an OFDM frame format results in the doubling or halving of the FFT size of the OFDM symbol. The OFDM frame formats and the extended OFDM frame format set are used dynamically in the wireless communication system in accordance to the changes of the communication environment.

FIG. 4 illustrates examples of resource allocation formats with a flexible time-frequency grid 400. Three different OFDM frame formats-Format 0, Format 1, and Format 2 coexist in flexible time-frequency grid 400 in the same time interval. Each grid in 400 represents a resource element (RE) for resource allocation. Note that each RE has predefined OFDM symbol length with corresponding subcarrier spacing such that each RE spans over the same area in the time-frequency grid. For example, from Format 0 to Format 1, the OFDM interval is halved but the subcarrier spacing is doubled. In addition, guard subcarriers depicted by slash shade are inserted for mixing of OFDM frame formats in the same time interval. For example, two guard subcarriers are inserted at location #1 and #2, where OFDM frame Format 0 and Format 1 are mixed in the same time interval; and six guard subcarriers are inserted at location #3 and #4, where OFDM frame Format 0 and Format 2 are mixed in the same time interval. More guard subcarriers are inserted when more inter-carrier interferences (ICI) are expected.

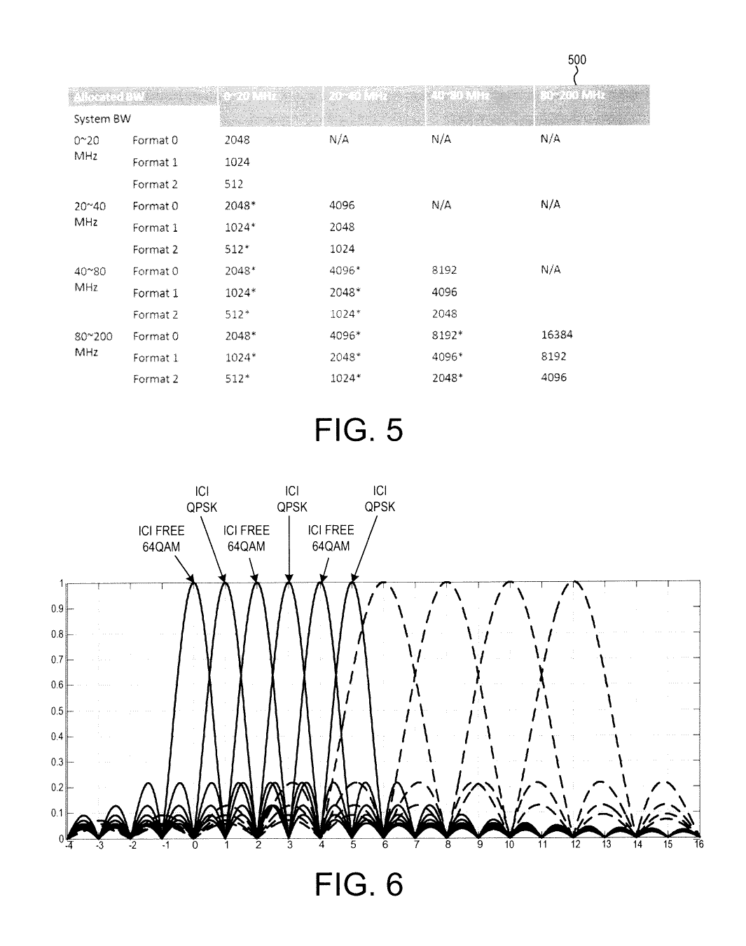

FIG. 5 illustrates examples of different resource allocation formats and corresponding system bandwidths and FFT sizes with flexible time-frequency grid. As illustrated in Table 500, different FFT size can be applied for different bandwidths based on different OFDM frame formats. The flexible time-frequency grid enables friendly UE implementation architectures. Because the sampling rates and FFT sizes are doubled or halved among different formats, such binary decimation can be implemented by doubling of the clock rate, and longer FFT size can be synthesized from smaller FFTs. As a result, it is easier to mix OFDM symbols of different sizes in a given time-frequency area. Other fractions such as ⅓ and ⅙ can also be added for more flexibility.

Because of different OFDM symbol configurations in the flexible time-frequency grid, performance degradation occurs on the REs interfered by non-orthogonal REs in the neighborhood. To improve performance against inter-carrier interference (ICI), the base station can identify the interfered subcarriers and improve robustness by applying lower order modulation and/or extra coding protection. The base station can also identify the interfered subcarriers and time samples and mitigate the ICI. Furthermore, the base station can provide RS information of neighbor subcarriers to the UE such that the UE can enhance the quality of channel estimation.

FIG. 6 illustrates a first embodiment of identifying interfered subcarriers and improving system robustness. In the first embodiment, the solid lines depict the desired signal while the dashed lines depict the interference signal. It can be seen that some subcarriers (e.g., with index 0, 2, 4) are ICI free subcarriers, while some other subcarriers (e.g., with index 1, 3, 5) suffer from ICI. Depending on the OFDM numerology of the neighboring allocated resource, the base station can identify the subcarrier indexes corresponding to the interfered subcarriers. For ICI free subcarriers, higher order modulation (e.g., 64QAM) can be used to carry the data since it requires higher SINR to demodulate. On the other hand, for interfered subcarriers, lower order modulation (e.g., QPSK) is used to carry the data since it requires less SINR to demodulate.

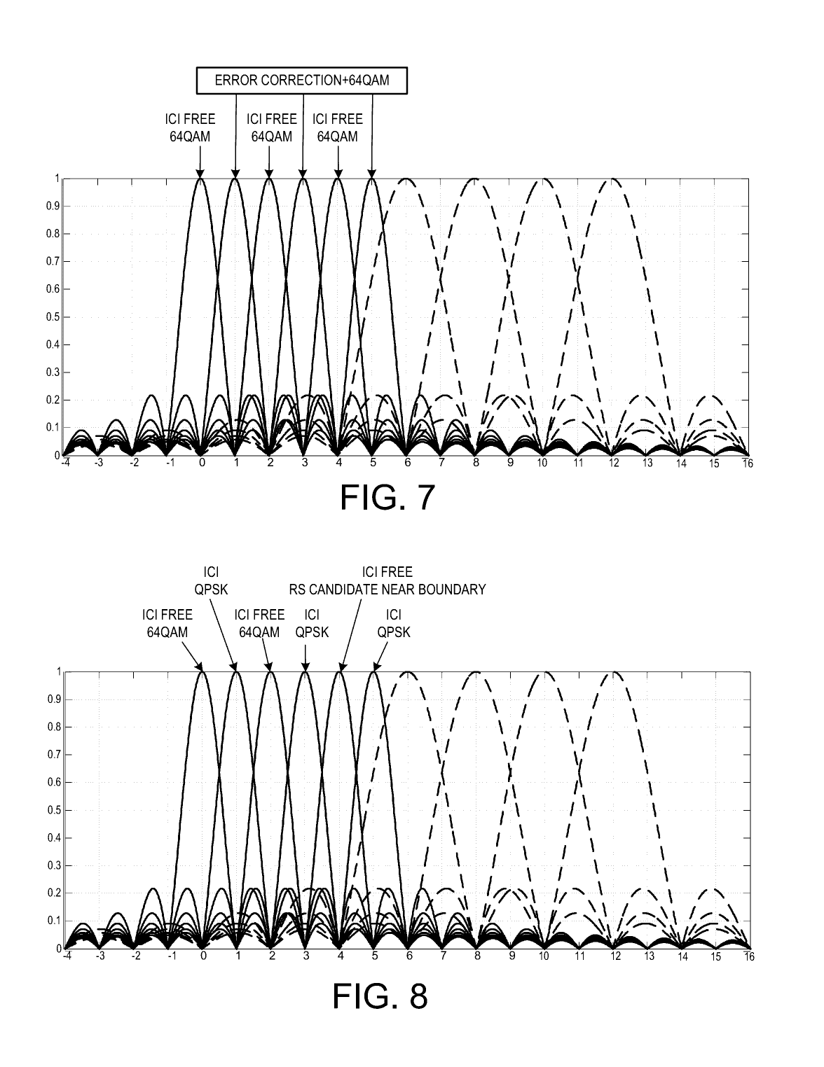

FIG. 7 illustrates a second embodiment of identifying interfered subcarriers and improving system robustness. In the second embodiment, the solid lines depict the desired signal while the dashed lines depict the interference signal. It can be seen that some subcarriers (e.g., with index 0, 2, 4) are ICI free subcarriers, while some other subcarriers (e.g., with index 1, 3, 5) suffer from ICI. Depending on the OFDM numerology of the neighboring allocated resource, the base station can identify the subcarrier indexes corresponding to the interfered subcarriers. For ICI free subcarriers, higher order modulation (e.g., 64QAM) can be used to carry the data since it requires higher SINR to demodulate. On the other hand, for interfered subcarriers, extra error correcting code can be used to protect the data since it requires less SINR to demodulate. For example, the error correcting code can be any type of repetition coding or block coding.

FIG. 8 illustrates a third embodiment of identifying interfered subcarriers and improving system robustness. In the third embodiment, the solid lines depict the desired signal while the dashed lines depict the interference signal. It can be seen that some subcarriers (e.g., with index 0, 2, 4) are ICI free subcarriers, while some other subcarriers (e.g., with index 1, 3, 5) suffer from ICI. Depending on the OFDM numerology of the neighboring allocated resource, the base station can identify the subcarrier indexes corresponding to the interfered subcarriers. For ICI free subcarriers, higher order modulation (e.g., 64QAM) can be used to carry the data since it requires higher SINR to demodulate. On the other hand, for interfered subcarriers, lower order modulation (e.g., QPSK) is used to carry the data since it requires less SINR to demodulate. In addition, for ICI free subcarriers that are near the boundary, e.g., subcarrier with index 4, it can be used as the subcarrier to carry reference signal for channel estimation with improved quality.

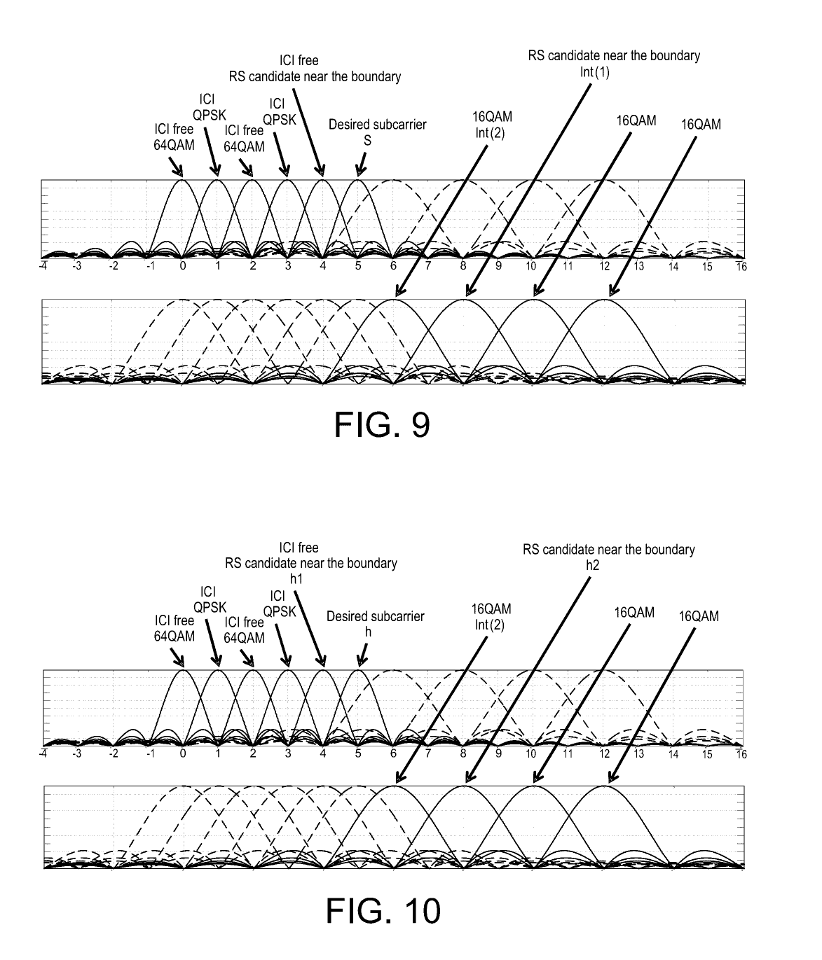

FIG. 9 illustrates one embodiment of interference mitigation with flexible time-frequency grid. In the top diagram of FIG. 9, the solid lines depict the desired signal intended for UE1 while the dashed lines depict the interference signal intended for UE2 from UE1 perspective. In the bottom diagram of FIG. 9, the solid lines depict the desired signal intended for UE2 while the dashed lines depict the interference signal intended for UE1 from UE2 perspective. By enabling the reference signal and data decoding of neighboring allocated resource, the UE can mitigate the interference of the desired data-carrying subcarrier. For example, the received signal R for UE1 can be expressed as: R=h*(S+a1*Int(1)+a2*Int(2)), where h is the channel response matrix on subcarrier index=5 for UE1. If UE1 can decode interference signals a1*Int(1) over neighbor subcarrier index=8 and a2*Int(2) over neighbor subcarrier index=6 intended for UE2, then UE1 is able to cancel the contribution from the interference signals and derive the desired signal on subcarrier index=5 S=R/h−a1*Int(1)−a2*Int(2).

FIG. 10 illustrates another embodiment of channel estimation with flexible time-frequency grid. In the top diagram of FIG. 10, the solid lines depict the desired signal intended for UE1 while the dashed lines depict the interference signal intended for UE2 from UE1 perspective. In the bottom diagram of FIG. 10, the solid lines depict the desired signal intended for UE2 while the dashed lines depict the interference signal intended for UE1 from UE2 perspective. By enabling the reference signal decoding of the neighboring allocated resource, the UE can improve the channel estimation quality of the desired subcarrier near the boundary, which would in turn improve the SINR of the desired signal. For example, the channel response matrix for desired subcarrier with index 5 is h, which suffers from ICI. Suppose h1 is the channel response matrix for neighbor subcarrier with index=4 that does not suffer ICI, and h2 is the channel response matrix for neighbor subcarrier with index=8 that does not suffer ICI. As a result, h can be enhanced by interpolating using the channel response matrix h1 and h2, which can be expressed as h=interpolate(h1,h2).

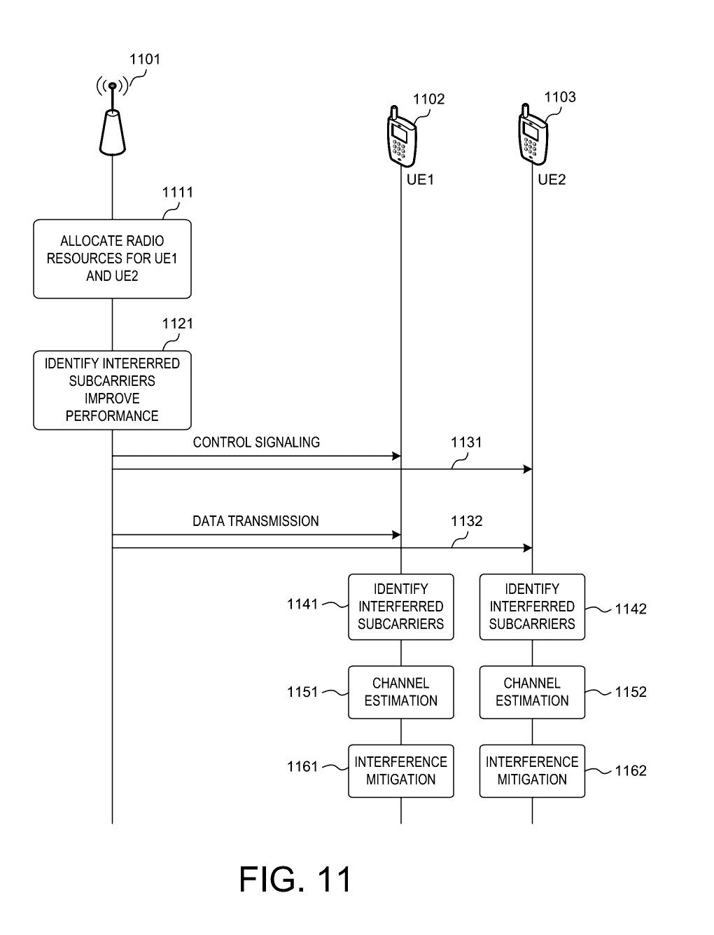

FIG. 11 illustrates message flows between a base station BS 1101 and user equipments UE 1102 and UE 1103 for data transmission with flexible time-frequency grid. In step 1111, BS 1101 performs downlink scheduling and allocates radio resources for UE 1102 (UE1) and UE 1103 (UE2). In one example, based on UE capability and other requirements, the allocated radio resources have different OFDM frame format mixed in the same time interval. In step 1121, BS 1101 identifies interfered subcarriers based on such resource allocation, and determines which method(s) to be used to improved performance. For example, BS 101 can apply lower order modulation or with extra error correction code over subcarriers that suffer from ICI. In another example, BS 101 can provide RS and resource allocation information of neighbor subcarriers (e.g., provide info of UE2 to UE1 and/or provide info of UE1 to UE2) such that the UE can perform enhanced channel estimation and interference cancellation. In step 1131, BS 1101 transmits control signaling to UE1 and UE2. In step 1132, BS 1101 transmits data signaling to UE1 and UE2.

At the receiver side, each UE can combat performance degradation caused by non-orthogonal REs in the neighboring subcarriers because of different OFDM symbol configurations in the flexible time-frequency grid. In steps 1141 and 1142, UE1 and UE2 identify interfered subcarriers via a specific formula based on the neighboring symbol's configuration (e.g., obtained from the control signaling in step 1131) and demodulate those subcarriers that are modulated with lower order modulation or applied with extra error correction coding. In steps 1151 and 1152, UE1 and UE2 perform more accurate channel estimation by using subcarriers near the resource allocation boundary that is not interfered by other subcarriers. In steps 1161 and 1162, UE1 and UE2 decode the RS and data carrying subcarriers of the neighboring allocated resource to be used to reconstruct the interfering signals for interference cancellation.

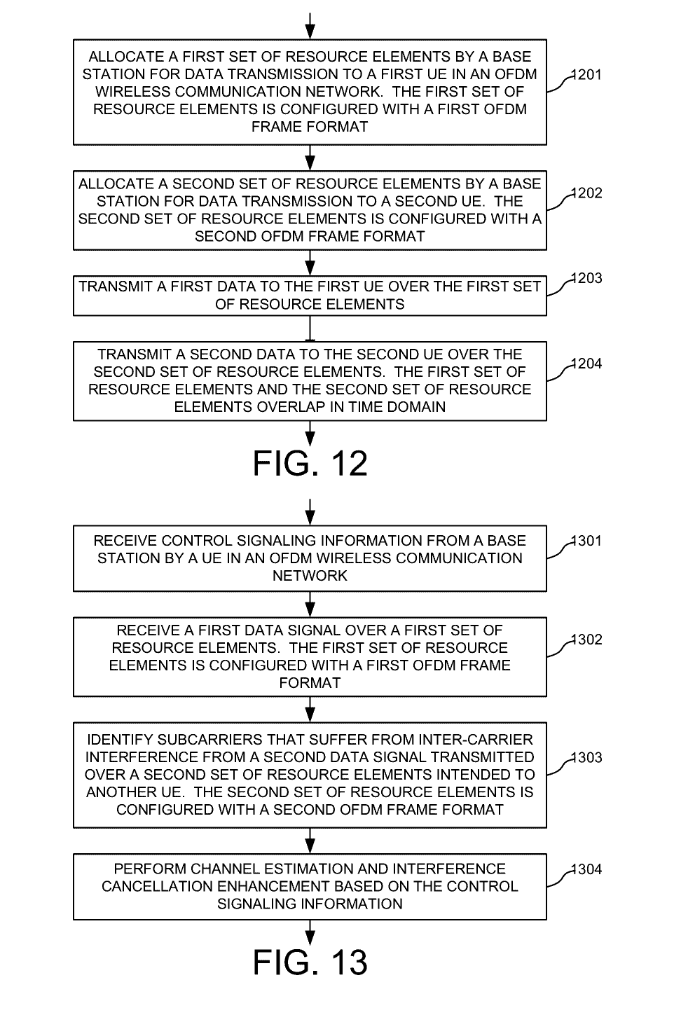

FIG. 12 is a flow chart of a method of using a flexible time-frequency grid from base station perspective in accordance with one novel aspect. In step 1201, a base station allocates a first set of resource elements for data transmission to a first user equipment (UE) in an OFDM wireless communication network. The first set of resource elements is configured with a first OFDM frame format. In step 1202, the base station allocates a second set of resource elements by the base station for data transmission to a second UE. The second set of resource elements is configured with a second OFDM frame format. In step 1203, the base station transmits a first data to the first UE over the first set of resource elements. In step 1204, the base station transmits a second data to the second UE over the second set of resource elements. The first set of resource elements and the second set of resource elements overlap in time domain.

FIG. 13 is a flow chart of a method of using a flexible time-frequency grid from user equipment perspective in accordance with one novel aspect. In step 1301, a user equipment (UE) receives control signaling information from a base station in an OFDM wireless communication network. In step 1302, the UE receives a first data signal over a first set of resource elements. The first set of resource elements is configured with a first OFDM frame format. In step 1303, the UE identifies subcarriers that suffer from inter-carrier interferences (ICI) from a second data signal transmitted over a second set of resource elements intended to another UE. The second set of resource elements is configured with a second OFDM frame format. In step 1304, the UE performs channel estimation and interference cancellation enhancement based on the control signaling information.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
allocating a first set of resource elements by a base station for data transmission to a first user equipment (UE) in an OFDM wireless communication network, wherein the first set of resource elements is configured with a first OFDM frame format;
allocating a second set of resource elements by the base station for data transmission to a second UE, wherein the second set of resource elements is configured with a second OFDM frame format;
transmitting a first data to the first UE over the first set of resource elements; and
transmitting a second data to the second UE over the second set of resource elements, wherein the first set of resource elements and the second set of resource elements overlap in time domain.

2. The method of claim 1, wherein the first OFDM frame format comprises a first cyclic prefix (CP) length plus a first OFDM symbol length, and wherein the second OFDM frame format comprises a second CP length plus a second OFDM symbol length.

3. The method of claim 2, wherein the first CP length is n times the length of the second CP length, wherein the first OFDM symbol length is n times the length of the second OFDM symbol length, and wherein n is a rational number.

4. The method of 2, wherein a first subcarrier spacing for the first OFDM frame format is n times shorter than a second subcarrier spacing for the second OFDM frame format.

5. The method of claim 1, wherein the base station inserts guard subcarriers near boundaries between the first set of resource elements and the second set of resource elements.

6. The method of claim 1, further comprising:
identifying a first plurality of subcarriers that suffers from inter-carrier interferences (ICI) for the first UE; and
applying a lower order modulation to the first plurality of subcarriers than other subcarriers.

7. The method of claim 1, further comprising:
identifying a first plurality of subcarriers that suffers from inter-carrier interferences (ICI) for the first UE; and
applying an additional error correction coding to the first plurality of subcarriers as compared to other subcarriers.

8. The method of claim 1, further comprising:
identifying one or more subcarriers near the first set of resource elements boundary that do not suffer from inter-carrier interferences (ICI) for the first UE; and
allocating a reference signal to be transmitted over the one or more identified subcarriers that do not suffer from ICI.

9. The method of claim 1, further comprising:
transmitting a control signal to the first UE about reference signal information to be transmitted to the second UE.

10. A base station, comprising:
a scheduler that allocates a first set of resource elements for data transmission to a first user equipment (UE) in an OFDM wireless communication network, wherein the first set of resource elements is configured with a first OFDM frame format, wherein the scheduler also allocates a second set of resource elements for data transmission to a second UE, wherein the second set of resource elements is configured with a second OFDM frame format; and
a transmitter that transmits a first data to the first UE over the first set of resource elements, wherein the transmitter also transmits a second data to the second UE over the second set of resource elements, wherein the first set of resource elements and the second set of resource elements overlap in time domain.

11. The base station of claim 10, wherein the first OFDM frame format comprises a first cyclic prefix (CP) length plus a first OFDM symbol length, and wherein the second OFDM frame format comprises a second CP length plus a second OFDM symbol length.

12. The base station of claim 11, wherein the first CP length is n times the length of the second CP length, wherein the first OFDM symbol length is n times the length of the second OFDM symbol length, and wherein n is a rational number.

13. The base station of 11, wherein a first subcarrier spacing for the first OFDM frame format is n times shorter than a second subcarrier spacing for the second OFDM frame format.

14. The base station of claim 10, wherein the base station inserts guard subcarriers near boundaries between the first set of resource elements and the second set of resource elements.

15. The base station of claim 10, further comprising:
a control circuit that identifies a first plurality of subcarriers that suffers from inter-carrier interferences (ICI) for the first UE; and
a modulator that applies a lower order modulation to the first plurality of subcarriers than other subcarriers.

16. The base station of claim 10, further comprising:
a control circuit that identifies a first plurality of subcarriers that suffers from inter-carrier interferences (ICI) for the first UE; and
an encoder that applies an additional error correction coding to the first plurality of subcarriers as compared to other subcarriers.

17. The base station of claim 10, further comprising:
a control circuit that identifies one or more subcarriers near the first set of resource elements boundary that do not suffer from inter-carrier interferences (ICI) for the first UE, wherein the base station allocates a reference signal to be transmitted over the one or more identified subcarriers that do not suffer from ICI.

18. The base station of claim 10, wherein the base station transmits a control signal to the first UE about reference signal information to be transmitted to the second UE.

19. A method, comprising:
receiving control signaling information from a base station by a user equipment (UE) in an OFDM wireless communication network;
receiving a first data signal over a first set of resource elements, wherein the first set of resource elements is configured with a first OFDM frame format;
identifying subcarriers that suffer from inter-carrier interferences (ICI) from a second data signal transmitted over a second set of resource elements intended to another UE, wherein the second set of resource elements is configured with a second OFDM frame format; and
performing channel estimation and interference cancellation enhancement based on the control signaling information.

20. The method of claim 19, wherein the control signaling information comprises information of reference signals transmitted over the second set of resource elements.

21. The method of claim 20, wherein the UE identifies reference signals over the second set of resource elements and enhances channel estimation via interpolation.

22. The method of claim 20, wherein the UE decodes reference signals and data over the second set of resource elements and reconstructs the second data signal for interference cancellation.
